(19) United States
(12) Patent Application Publication
(10) Pub. No.: US 2002/0046653 A1
(43) Pub. Date: Apr. 25, 2002

(54) Apparatus and method for avoiding gas bubbles when transporting a liquid by means of pumps

(76) Inventors: Eggo Sichmann, Gelnhausen (DE); Patrick Binkowska, Westerngrund (DE); Johannes Richter, Dieburg (DE); Reiner Rohrmann, Freigericht (DE); Stefan Kempf, Alzenau Albstadt (DE)

Correspondence Address: JOHN R. WETHERELL, Jr., Pillsbury Winthrop LLP, Suite 1800, 101 W. Broadway, San Diego, CA, 92101, US

(21) Appl. No.: 09/954,701

(22) Filed: Sep. 14, 2001

(30) Foreign Application Priority Data
Sep. 15, 2000 (DE) 100 45 659.6
Jan. 8, 2001 (DE) 101 00 508.3
Jan. 18, 2001 (DE) 101 02 142.9

(51) Int. Cl. B01D 19/00

(52) U.S. Cl. 95/266; 96/193

(57) ABSTRACT

The present invention provides an apparatus and a method for avoiding gas bubbles when transporting a liquid. The apparatus comprises a conditioning container in which the liquid is degassed due to a low pressure. In a supply container, which is arranged downstream of the conditioning container, the degassed liquid is preferably pumped out preferably by means of a plunger pump which is submerged below the surface of the liquid. The plunger pump has a stationary piston and a movable cylinder, wherein the cylinder pumps liquid through an opening of the piston into an outlet conduit. Since the piston and the cylinder are arranged in the liquid, gas bubbles are prevented from entering the liquid to be transported.

The invention relates to an apparatus and a method for avoiding gas bubbles when transporting a liquid by means of pumps and can, in particular, be used for removing gas bubbles in viscous liquids, e.g. a lacquer or a bonding agent.

Preferably, the invention can be used for the surface coating of or the application of lacquer or a bonding agent to substrates of disk-shaped data carriers as described, for example, in U.S. Pat. No. 5,766,359 (corresponding to DE-C1-196 05 602).

U.S. Pat. Nos. 1,180,221 and 4,662,544 and German patent 75 111 disclose piston pumps submerged below the surface of the liquid to be pumped.

It is the object of the present invention to provide an apparatus and a method in which gas can reliably be removed from a liquid, in particular a highly viscous liquid, before processing the liquid, for example, during application as a lacquer or a bonding agent.

This object is achieved with the features of the claims.

In achieving the object, the invention starts out from the basic idea of conditioning the liquid first in a conditioning container at a low pressure or a partial vacuum (e.g. preferably at 10 to 100 mbar) and then transferring the thus conditioned, degassed liquid into a container which is arranged downstream of the conditioning container and from which the liquid can then be pumped out so that it can be used.

Preferably, a plunger pump is arranged in a container which is filled with a degassed liquid such that during operation the cylinder and the piston of the plunger pump are below the surface of the liquid and thus completely covered with the liquid.

The piston of the plunger pump is in particular stationary and provided with a through-opening being connected with a conduit for transporting the liquid. The cylinder is in particular movable with respect to the piston and provided with a check-valve, so that liquid is allowed to enter the space between the cylinder and the piston when the cylinder is moved towards the liquid. When the cylinder moves towards the stationary piston, the check-valve is closed and the liquid is pressed through the opening of the piston into a conduit for transporting the liquid away.

In the conditioning container for the liquid a low pressure of preferably 10 to 900 mbar or even 10 to 100 mbar is maintained at least for some time but preferably at any time during operation. This conditioning container is preferably heatable. Preferably, the low pressure causes the liquid to enter the conditioning container in which it stays for a predetermined period of time. Due to the low pressure and optionally due to the heater, gas bubbles, which are possibly present in the liquid, become bigger, or gas bubbles are generated from a gas being dissolved in the liquid. The thus generated gas bubbles displace a larger amount of liquid and thus have a higher buoyancy so that they move through the, for example, viscous liquid relatively quickly to the surface. Here they are sucked off by a means for generating the low pressure. After the predetermined time period has passed, the connection between the conditioning container and the supply container is opened and the liquid can flow, for example due to the influence of the gravitational force, into the supply container.

Advantageously, by means of the invention largely bubble-free e.g. lacquer layers or bonding agent layers can be produced, so that e.g. defects and/or failures e.g. in coated disk-shaped substrates for CDs (compact disks) or DVDs (digital versatile disks) can be avoided.

The system according to the present invention can advantageously be used, for example, instead of the container 31 and the pump 29 in the system according to DE-C1-196 05 602.

In the following the present invention is described in more detail on the basis of the drawings in which

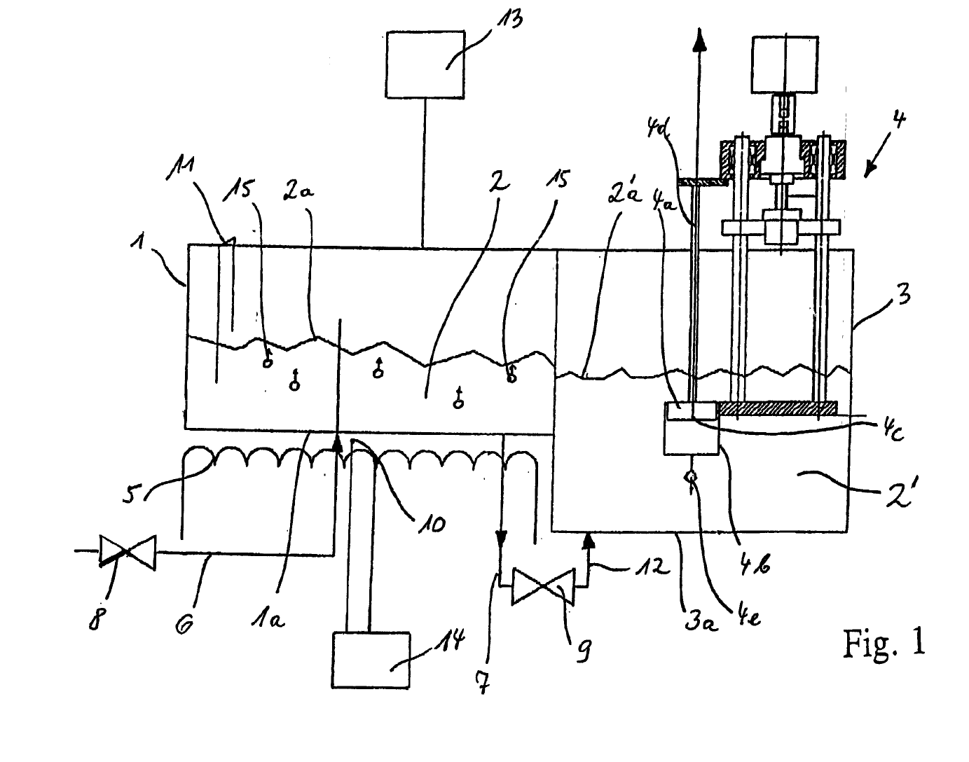

FIG. 1 is a principle drawing of an embodiment of the present invention,

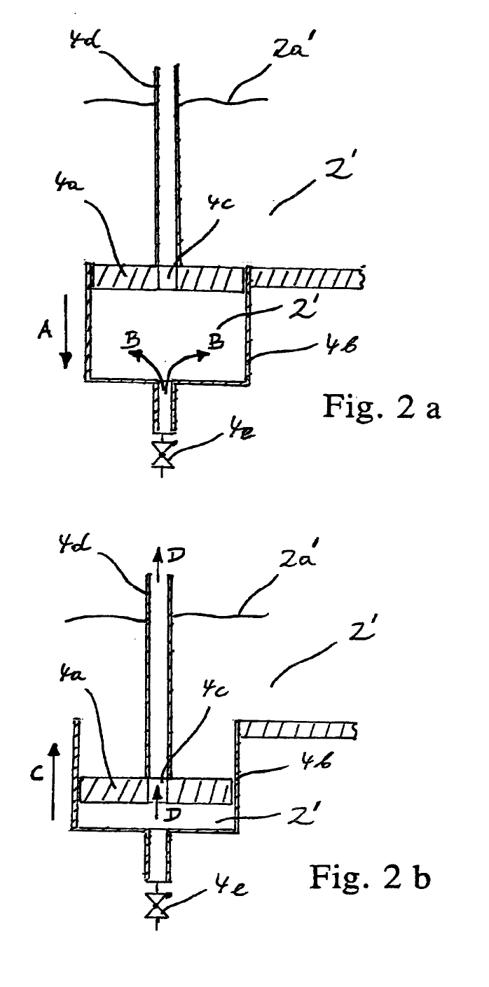

FIG. 2a is an enlarged view of the piston and the cylinder according to FIG. 1 during sucking liquid into the cylinder,

FIG. 2b is an enlarged view of the piston and the cylinder according to FIG. 1 during removal of the liquid from the cylinder.

The embodiment of the invention according to FIG. 1 comprises a conditioning container 1 for the liquid 2 to be degassed. In said container 1 a low pressure is generated by means of a vacuum pump 13, and a supply container 3 is arranged downstream of said container 1 in accordance with FIG. 1. Preferably, due to the influence of the low pressure, the liquid 2 is sucked into the conditioning container 1 via the conduit 6 when the valve 8 is open. The liquid stays in the conditioning container 1 for a predetermined period of time (e.g. 3 to 8 minutes), wherein it can be heated preferably by means of a schematically shown heater 5. The gas bubbles 15 contained in the liquid 2 become bigger due to the influence of the low pressure and the increase in the temperature of the liquid, have an additional buoyancy, leave the surface 2a of the liquid 2 and are sucked off by the vacuum means 13. The level in the conditioning container 1 is controlled by a level indicator 11. Moreover, a temperature sensor 10 which controls the power supply from a current source 14 to the heater 5 is provided. After the predetermined time period has passed, a valve 9 is opened and the thus degassed liquid is passed through the conduits 7 and 12 into the supply container 3 due to the influence of the gravitational force.

In the supply container 3 for the degassed liquid 2′, a plunger pump 4 is arranged. This plunger pump 4 has a movable cylinder 4b and a stationary piston 4a which are arranged below the surface of the liquid 2′. The piston 4a has a through-opening 4c which is connected with an outlet conduit 4d for transporting the liquid. A check-valve 4e is located at the bottom of the cylinder 4b. When the cylinder 4b moves away from the piston 4a (i.e., in the downward direction in FIG. 1), the check-valve 4e opens and allows the liquid 2 to flow into the interior of the cylinder 4b. When moving back, i.e. when the cylinder 4b moves towards the stationary piston 4a (i.e., in the upward direction in FIG. 1), the check-valve 4c is closed and the cylinder presses the liquid through the opening 4c into the outlet conduit 4d. Since the plunger pump 4 is arranged below the surface 2a′ of the liquid, it is avoided that gas and/or air bubbles can enter due to a possible leakage in the sealing ring of the piston. Moreover, liquid which can escape the cylinder through a leakage is again collected in the supply container 3.

FIGS. 2a and 2b show enlarged views of the piston and the cylinder of the plunger pump during operation. According to FIG. 2a, the cylinder 4b moves away from the stationary piston 4a in the direction of the arrow A, wherein the check-valve 4e opens and liquid 2′ flows in the direction of the arrow B into the interior of the cylinder 4b. In FIG. 2b the cylinder 4b moves in the direction of the arrow C towards the stationary piston 4a, wherein the check-valve 4e is closed and the liquid is pressed in the direction of the arrow D through the opening 4c into the outlet conduit 4d which supplies the liquid to a suitable application, e.g. a lacquer or bonding agent head (not shown) for applying lacquer or bonding agent onto the surface of a substrate.

In accordance with the invention, the liquid is thus first degassed in a conditioning container. By using a plunger pump for transporting the liquid, the formation of bubbles in the liquid is minimized because of the specific inventive arrangement of the piston and the cylinder below the surface of the liquid.

The liquid is preferably a lacquer or a bonding agent which can be used for a suitable coating of substrates for CDs or DVDs.

1. An apparatus for degassing a liquid (2) in a liquid transportation line comprising a supply conduit (6) for supplying the liquid (2) to a conditioning container (1), a means (13) for generating a low pressure in the conditioning container (1) and a supply container (3) being arranged downstream of the conditioning container (1) and serving for storing the degassed liquid (2′):

2. The apparatus according to claim 1, wherein the conditioning container (1) comprises a heater (5) for the liquid (2).

3. The apparatus according to any one of claims 1 or 2, wherein the conditioning container (1) comprises a supply conduit (6) having a valve (8) as well as a discharge conduit (7) having a valve (9).

4. The apparatus according to claim 3, wherein the supply conduit (6) and the discharge conduit (7) are connected with the bottom (1a) of the conditioning container (1).

5. The apparatus according to any one of claim 1 to 4, wherein the low pressure is generated by a prevacuum pump (13).

6. The apparatus according to claim 5, wherein the prevacuum pump comprises a Venturi nozzle.

7. The apparatus according to claim 5 or 6, wherein the low pressure is 10 to 900 mbar, preferably 10 to 100 mbar.

8. The apparatus according to any one of claims 1 to 7 comprising a temperature sensor (10) for controlling the heater (5).

9. The apparatus according to any one of claims 1 to 8 comprising a liquid indicator (11) in the conditioning container (1) and/or the supply container (3).

10. The apparatus according to any one of claims 1 to 9, wherein the discharge conduit (7) of the conditioning container (1) and an inlet conduit (12) of the supply container (3) are connected with each other via the valve (9).

11. The apparatus according to any one of claims 1 to 10 comprising a pump (4) for pumping the liquid from the supply container (3) into an outlet conduit (4d).

12. The apparatus according to claim 11, wherein the pump is a submerged pump, preferably a plunger pump (4) the piston (4a) and the cylinder (4b) of which are submerged below the surface (2a) of the liquid (2′) during operation.

13. The apparatus according to claim 12, wherein the plunger pump (4) comprises a stationary piston (4a) and a cylinder (4b) which is movable with respect to the piston (4a).

14. The apparatus according to claim 12 or 13, wherein the piston (4a) has a through-opening (4c) which is connected with the outlet conduit (4d).

15. The apparatus according to claim 12, 13 or 14, wherein the cylinder (4b) comprises a check-valve (4e) which opens and allows liquid (2′) to enter the cylinder (4b) when the cylinder (4b) moves away from the piston (4a) and closes when the cylinder (4b) moves towards the piston (4a), so that the liquid (2′) in the cylinder (4b) is pressed through the opening (4c) into the outlet conduit (4d).

16. The apparatus according to claim 12, 13, 14 or 15, wherein there is an atmospheric pressure in the supply container (3).

17. The apparatus according to any one of claims 12 to 16, wherein an inlet conduit (12) of the supply container (3) is arranged below the liquid level (2a′), preferably at the bottom (3a) of the supply container (3).

18. A method for bubble-freely pumping a liquid by means of the apparatus according to any one of claims 1 to 17, comprising the following steps:
(a) supplying the liquid (2) into the conditioning container (1);
(b) degassing the liquid (2) by adjusting a low pressure in the conditioning container (1);
(c) transferring the liquid (2) from the conditioning container (1) into the supply container (3).

19. The method according to claim 18 which is carried out by means of the apparatus according to any one of claims 12 to 17 comprising a plunger pump (4) in the supply container (3), wherein by moving the cylinder (4b) away from or towards the piston (4a) the check-valve (4e) opens or closes and liquid (2′) enters the cylinder (4b) or is pumped through the opening (4c) into the outlet conduit (4b).

20. The method according to claim 18 or 19, wherein in method step (b) the liquid (2) is degassed during a time period of 3 to 8 minutes.

21. The method according to claim 18, 19 or 20, wherein the liquid (2) in the conditioning container (1) is heated.

22. The method according to claim 18, 19, 20 or 21, wherein due to a low pressure the liquid (2) is sucked into the conditioning container (1) via the conduit (6).

23. The apparatus and the method according to any one of claims 1 to 17 or 18 to 22, respectively, wherein the liquid (2) is a lacquer or a bonding agent.

24. Use of the apparatus and the method according to claim 23 during the application of a lacquer or a bonding agent onto a substrate in the form of a data carrier such as a CD, a DVD or a DVD half.
